(19) United States
(12) Patent Application Publication
(10) Pub. No.: US 2019/0007726 A1
(43) Pub. Date: Jan. 3, 2019

(54) AUDIO, VIDEO, AND ACTUATION (A/V/A) SYNCHRONIZATION FOR MIXED REALITY

(71) Applicant: Intel Corporation, Santa Clara, CA (US)

(72) Inventor: Glen J. Anderson, Beaverton, OR (US)

(21) Appl. No.: 15/639,921

(22) Filed: Jun. 30, 2017

(51) Int. Cl. H04N 21/43; H04N 21/8547; H04N 21/435; H04N 21/442; H04N 21/81; G08B 6/00; H04N 5/04

(52) U.S. Cl. CPC H04N 21/4307; H04N 21/8547; H04N 21/435; H04N 5/04; H04N 21/8126; G08B 6/00; H04N 21/44218

(57) ABSTRACT

Systems, apparatuses and methods for monitoring and adjusting audio/video/actuation (A/V/A) synchronization to ensure immersive mixed reality experiences. The method includes preparing the mixed reality content with timestamp metadata in the content stream to describe modality synchronization requirements. The mixed reality content is presented. Synchronization between components of the mixed reality content is monitored. The system determines whether the components of the mixed reality content are in synchronization. If they are not in synchronization, the system may take action to improve the perception of the A/V/A synchronization.

### TECHNICAL FIELD

Embodiments generally relate to synchronizing audio, video and actuation (A/V/A) signals for mixed reality experiences. More particularly, embodiments relate to monitoring and adjusting A/V/A synchronization to help ensure an immersive mixed reality experience for the user.

### BACKGROUND

Humans have a limited tolerance for viewing media in which the audio and video are out of sync. For example, the Advanced Television Systems Committee recommends that audio/video sync be within 15 ms when audio leads video and 45 ms when audio lags video to meet user expectations.

With virtual reality (VR) and augmented reality (AR) added to the mix, additional sync issues may arise. For example, VR and/or AR systems with wearables or objects that supply haptic output not only need the audio and video to be in sync, but the haptic output must be in sync with the video and/or audio output.

### BRIEF DESCRIPTION OF THE DRAWINGS

The various advantages of the embodiments will become apparent to one skilled in the art by reading the following specification and appended claims, and by referencing the following drawings, in which:

FIG. 1 is an example of a mixed reality experience in which A/V/A synchronization is needed to provide users with an immersive mixed reality experience according to an embodiment;

FIG. 2 is an example of a mixed reality experience in which A/V synchronization is needed to provide users with an immersive mixed reality experience according to an embodiment;

FIG. 3 is a block diagram of an exemplary system architecture 100 for monitoring and adjusting A/V/A synchronization to provide the user with an immersive mixed reality experience according to an embodiment;

FIG. 4A is a flow diagram of an exemplary method for monitoring and adjusting A/V/A synchronization in real-time according to an embodiment;

FIG. 4B is a flow diagram of an exemplary method for predicting A/V/A synchronization according to an embodiment;

FIG. 5 is a flow diagram of an exemplary method for making adjustments to improve perception of A/V/A synchronization according to an embodiment;

FIG. 6 is a block diagram of an exemplary system for monitoring and adjusting/predicting A/V/A synchronization according to an embodiment;

FIG. 7 is an illustration of an example of a semiconductor package apparatus according to an embodiment;

FIG. 8 is a block diagram of an exemplary processor according to an embodiment; and

FIG. 9 is a block diagram of an exemplary computing system according to an embodiment.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

### DESCRIPTION OF EMBODIMENTS

Technology for monitoring and adjusting audio, video, and actuation (A/V/A) synchronization is described herein. A system prepares mixed reality content by inserting timestamp metadata in the content stream for audio, video, and actuation components to allow for tracking the A/V/A syncs. The system presents the mixed reality content and monitors the synchronization of the A/V/A mixed reality signals. When excessive A/V/A de-sync cannot be avoided, the system may compensate by cancelling actuation commands in the content stream. In another embodiment, the system may compensate by sending a flurry of haptic output, consistent with the storyline of the content to cover for excessive de-sync. Data enabling A/V/A synchronization may come from wearables, hand-held controllers, environment-based cameras and other sensors, and the audio and/or video streams. The system may be applied to multiplayer online games, other virtual environment A/V content, augmented reality (AR), virtual reality (VR), and combined AR and VR experiences. These and other aspects of the present disclosure will be more fully described below. In some embodiments, a system may include one or more processors and one or more modules to be executed by the one or more processors to monitor and adjust the synchronization of mixed reality A/V/A in real-time. In another embodiment, a semiconductor package apparatus may include a substrate with logic coupled to the substrate, the logic to monitor and adjust the synchronization of mixed reality A/V/A in real-time.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device). As used herein, the term “logic” and “module” may refer to, be part of, or include an application specific integrated circuit (ASIC), an electronic circuit, a processor (shared, dedicated, or group), and/or memory (shared, dedicated, or group) that execute one or more software or firmware programs having machine instructions (generated from an assembler and/or a compiler), a combinational logic circuit, and/or other suitable components that provide the described functionality.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

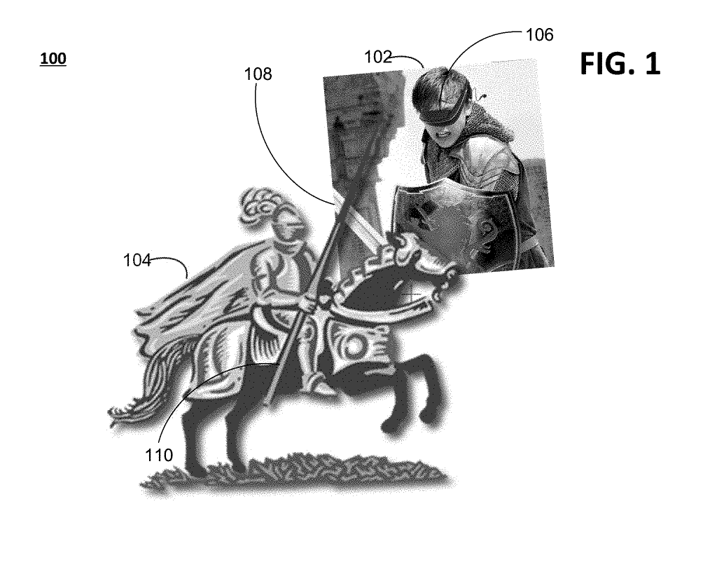

FIG. 1 is an example of a mixed reality experience in which A/V/A synchronization is needed to provide users with an immersive mixed reality experience according to an embodiment. Shown in FIG. 1 is a young man 102 performing an augmented reality fight with a virtual knight on a horse 104 as his opponent. The young man 102 is wearing a head-mounted display 106 that allows him to view the knight on the horse 104. The young man 102 is carrying a sword 108 and the knight on the horse is also carrying a sword 110. Although not clearly shown in FIG. 1, the young man is also wearing a wrist-based device on his arm. The wrist-based device is capable of producing haptic output based on the actions of the augmented reality sword fight between the young man 102 and the knight on the horse 104.

Contact between the young man 102 and the knight 104 occurs when the two swords 108 and 110 clash. In embodiments, virtual contact with the virtual opponent 104 may be tracked to monitor and adjust audio, video, and haptic (actuation) synchronization. The audio and video outputs occur on the head-mounted display 106, while the haptic output occurs on the wrist-based device. From the user's view (i.e., the young man's 102 view), the sword strikes of the opponent 104 would be synced with the wrist-based device haptics. The audio, video, and haptics must be synched in order for the young man to be immersed in the augmented reality duel. For example, when the young man 102 sees the two swords 108 and 110 clash through the head-mounted display, the audio (provided by the head-mounted display) should provide a sword clashing sound and the haptic output on the wrist-based device may provide some kind of a pulse/jolt for the young man 102 to feel. All of this should occur within a few milliseconds to feel authentic. If the video and audio are in sync, but the haptic reaction does not occur for another 2 seconds, the young man 102 may not associate the haptic reaction with the sword clash that happened 2 seconds ago or the young man 102 may realize that the system is out of sync, thus, pulling him out of the augmented reality immersive experience. If the sync level for video, audio, and/or haptics is not satisfactory, embodiments allow for certain actions to occur to improve the perception of A/V/A synchronization.

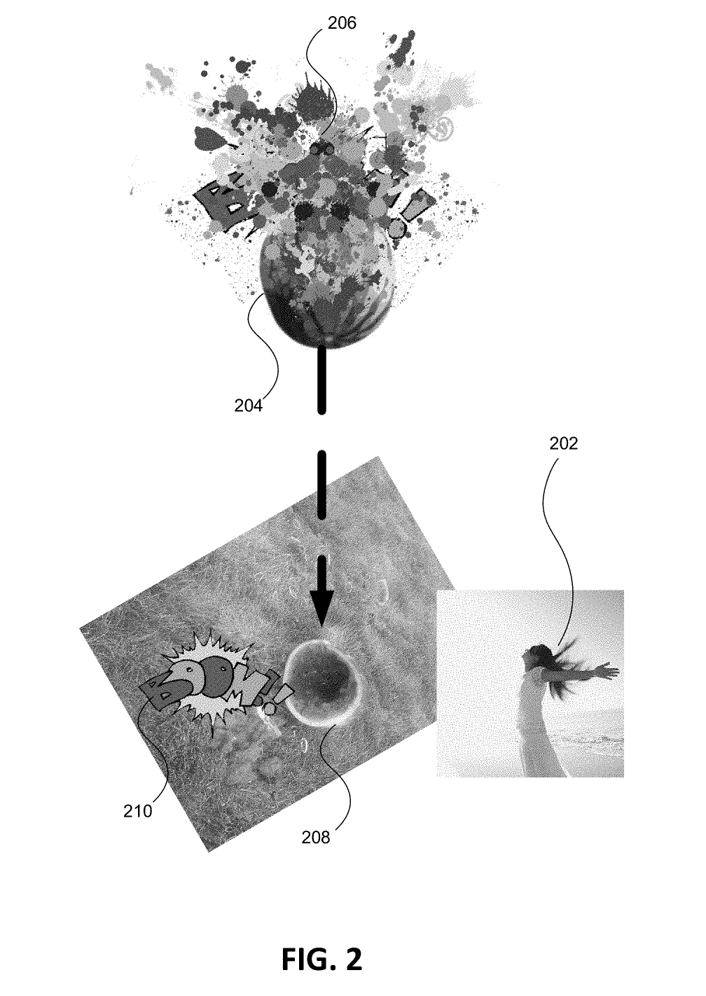

FIG. 2 is an example of a mixed reality experience in which A/V synchronization is needed to provide users with an immersive mixed reality experience according to an embodiment. In this example, a young girl 202 throws an object into the air. Through the head-mounted display, the young girl 202 sees the object as a large virtual watermelon 104 in augmented reality. In mid air, the virtual watermelon explodes with visual and sound effects and falls to the ground with more visual and sound effects, but no haptic effects. The young girl 202, may see and hear the visual and sound effects through the headmounted display. In such embodiments, the audio and video must be synched in order for the young girl 202 to be immersed in the augmented reality experience. In other words, the system monitors both audio and video synchronization for augmented reality. A delay of seconds with the audio or video may alter the augmented reality immersive experience for the young lady 202. The disclosed system monitors A/V/A synchronization and takes action to compensate for excessive A/V/A de-sync.

As another example, haptics may be added to FIG. 2. A haptic device, such as, for example, a vibrating device, may be placed in the young girl's 202 shoe to provide a vibrating feeling when the watermelon explodes and when the watermelon lands on the ground. In this instance, audio, video, and actuator must be synchronized in order for the young lady 202 to be immersed in the augmented reality experience. If any one of the synchronization signals (i.e., audio, video, or actuator) is off, embodiments of the system may take action to improve the perception of audio/video/actuator synchronization.

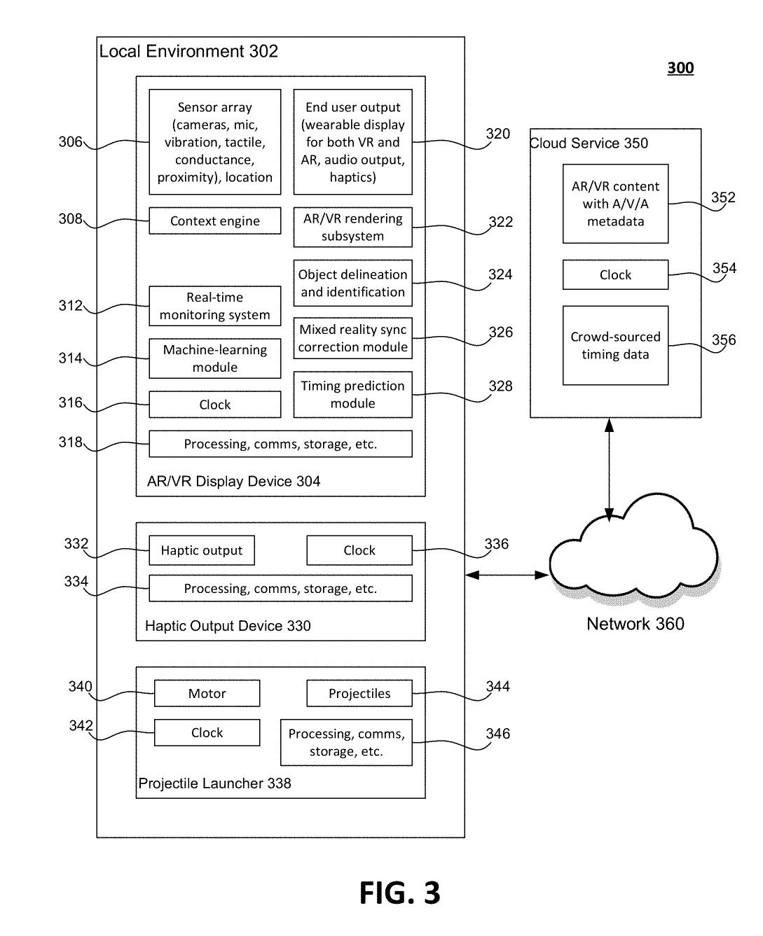

FIG. 3 is a block diagram of an exemplary system architecture 100 for monitoring and adjusting A/V/A synchronization to provide the user with an immersive mixed reality experience according to an embodiment. System 300 may include a network 360, a cloud service 350, and a plurality of AR/VR devices, such as, for example, an AR/VR display device 304, a haptic output device 330, and a projectile launcher 338. The cloud service 350 may be located in the cloud to provide an AR/VR cloud service. The AR/VR display device 304, the haptic output device 330, and the projectile launcher 338 may be located in close proximity to the user. The cloud service 350, the AR/VR display device 304, the haptic output device 330, and the projectile launcher 338 may communicate with each other via the network 360.

Network 360 may comprise one or more wired and/or wireless communications networks. Network 360 may include one or more network elements (not shown) to physically and/or logically connect computer devices to exchange data with each other. In some embodiments, network 360 may be the Internet, a wide area network (WAN), a personal area network (PAN), a local area network (LAN), a campus area network (CAN), a metropolitan area network (MAN), a virtual local area network (VLAN), a cellular network, a Wi-Fi network, a WiMAX network, and/or the like. Additionally, in some embodiments, network 360 may be a private, public, and/or secure network, which may be used by a single entity (e.g., a business, school, government agency, household, person, and the like). Although not shown, network 360 may include, without limitation, servers, databases, switches, routers, gateways, firewalls, base stations, repeaters, software, firmware, intermediating servers, and/or other components to facilitate communication.

In some embodiments, cloud service 350 may include a server (not explicitly shown). The server may comprise one or more computers, processors, or servers having one or more modules with machine instructions configured to monitor and adjust audio, video, and actuation synchronization for mixed reality environments (augmented reality (AR), virtual reality (VR), and/or a mix of the two) described herein. The machine instructions may be generated from an assembler or compiled from a high level language compiler. Cloud service 350 may communicate with AR/VR display device 304, haptic output device 330, and for project launcher 338 via network 360. The server may host one or more applications accessed by any of the devices located in local environment 302 and/or execute one or more computer readable instructions to facilitate operation of the one or more output devices located in local environment 302. In some embodiments, cloud service 350 may include AR/VR content with A/V/A metadata 352, a clock 354, and crowd-sourced timing data 356. Cloud service 350 may provide processing functionalities for any of the devices located in local environment 302. For example, cloud service 350 may provide data to and/or receive data from AR/VR display device 304, haptic output device 330, and/or projectile launcher 338; monitor A/V/A synchronization for AR/VR display device 304, haptic output device 330, and/or projectile launcher 338; predict A/V/A synchronization for AR/VR display device 304, haptic output device 330, and/or projectile launcher 338; and make adjustments to improve perception of A/V/A synchronization for AR/VR display device 304, haptic output device 330, and/or projectile launcher 338; and the like, to be described in greater detail below.

AR/VR content with A/V/A metadata 352 provides content stream data to the devices in local environment 302. Timestamp metadata for audio, video, and actuation is inserted in the content streams to allow tracking of A/V/A synchronization. The content stream data tells each device what to play and/or what to actuate.

Clock 354 is used to synchronize audio, video, and actuation. The cloud service 350 may be used to remove offset. Clock 354 may be a shared real-time system clock, such as, for example, Network Time Protocol (NTP).

Crowd-sourced timing data 356 includes the collection of A/V/A timing data from a large number of mixed reality users. The crowd-sourced timing data 356 may be used, in conjunction with machine learning, to tune A/V/A synchronization in various devices and usages. This may include actual queries to users about satisfaction with A/V/A synchronization of mixed reality content. This may also include automated monitoring of various devices, such as, for example, motors, to determine responsiveness.

AR/VR display device 304 may be any display device capable of playing mixed reality content. Such devices may include, but are not limited to, headmounted displays, LCD panels, and the like for displaying video content. Audio content may be played using speaker arrays, headphones, and the like. AR/VR display device 304 may include a sensor array 306, a context engine 308, a real-time monitoring system 312, a machine-learning module 314, a clock 316, a processing/computing unit 318, end user output 320, an AR/VR rendering subsystem 322, an object delineation and identification module 324, a mixed reality sync correction module 326, and a timing prediction module 328.

Sensor array 306 may include a plurality of sensors, detectors, or other mechanisms strategically positioned to obtain information about the real world environment associated with a user. The types of sensors found in sensor array 306 may include, but are not limited to, cameras (e.g., two-dimensional (2D), three-dimensional (3D), depth, infrared, fish-eye, etc.), microphones, touch sensors, proximity detectors, motion detectors, accelerometers, gyroscopes, location sensors, vibration sensors, global positioning satellite (GPS) sensors, and the like.

Context engine 308 may receive sensor input data from the sensor array 306 to discern information about the real world environment associated with the user. In one embodiment, context engine 308 may be used to discern user distraction. User distraction plays an important role when excessive A/V/A de-sync cannot be avoided. In fact, distracting a user when excessive A/V/A de-sync occurs may divert the user's attention from system latency issues when under a high cognitive load.

Real-time monitoring system 312 may receive timestamp data from various output devices. The timestamp data may be used to track A/V/A synchronization from the various output devices. Each output device reports timestamps indicating when their output actually occurred. For example, if a motor is slow to spin up, the instrumentation within the motor may record when it reached a certain velocity that enabled the user to actually feel the output, and if there is a delay, that delay will be reported from the clock on that output device.

Machine-learning module 314 may be used with crowd-sourced timing data to enable data from a large number of other mixed reality users to be used to make predictions regarding A/V/A synchronization. In one embodiment, machine-learning module 314 may be used to tune A/V/A synchronization in various devices and usages. In embodiments, machine-learning module 314 may include a history tracking feature to allow the system to track when haptic output is successfully synchronized for specific users, across users, and specific devices. In one embodiment, the system may query the user about relative satisfaction with A/V/A synchronization to better enable machine learning.

Clock 316 may be a shared real-time system clock, such as, for example, Network Time Protocol (NTP). Clock 316 may be used to report when A/V/A synchronization occurs for the AR/VR display device 304.

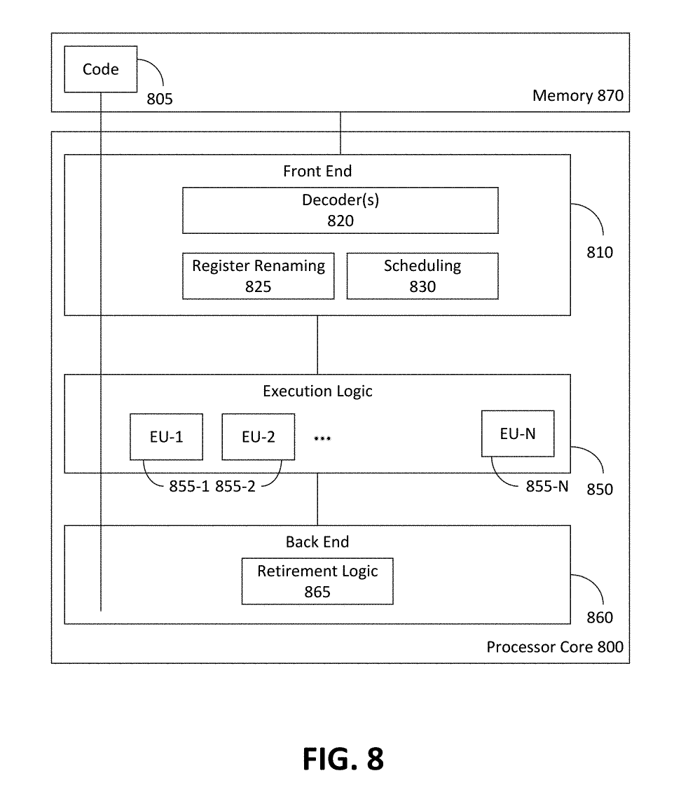

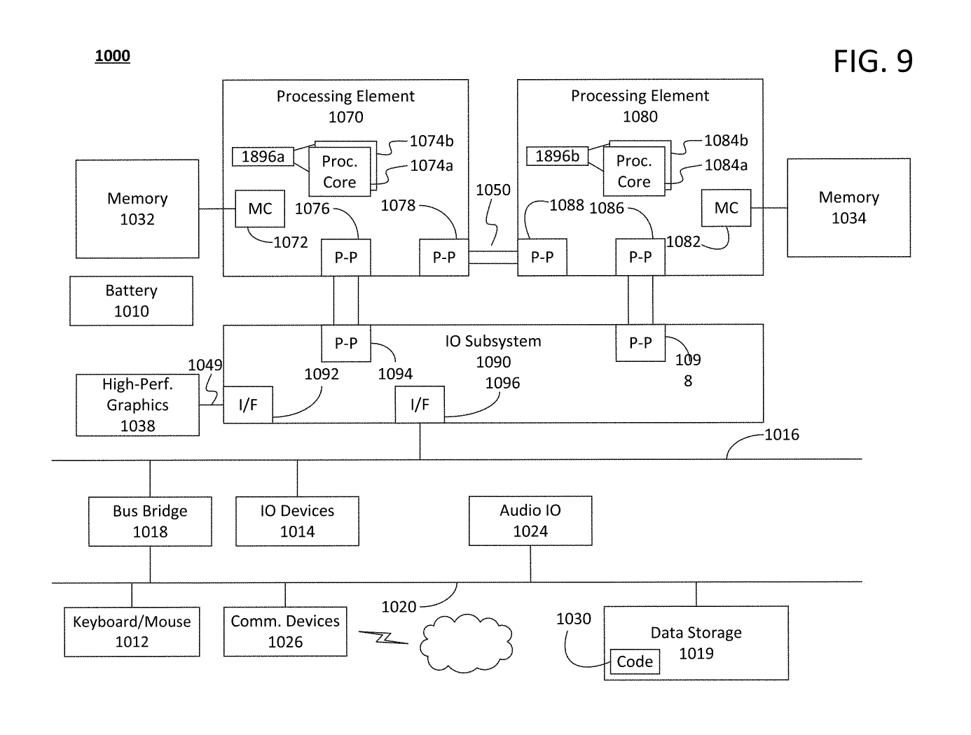

Computing device 318 may be capable of delivering AR and/or VR content with actuation, such as haptics. Computing device 318 is described in more detail below with reference to FIGS. 8 and 9.

End user output 320 may include, but is not limited to, a wearable display for both VR and AR, audio output, and haptics. In some embodiments, the visual AR content may be projected into the user's environment. In some embodiments, the visual AR content may be projected while the haptic AR content may be delivered through a wearable device.

AR/VR rendering subsystem 322 renders objects within an AR experience for AR rendering. AR/VR rendering subsystem 322 renders objects within a VR experience for VR rendering.

Object delineation and identification module 324 may be configured to detect and identify real life objects as they enter into the system. The real life object may be virtually replaced in VR or augmented with an AR element in AR.

Mixed reality sync correction module 326 may be configured to take action to improve A/V/A synchronization. Based on inputs from the real-time monitoring subsystem 312, the context engine 308, and the timing prediction module 328, the mixed reality sync correction module 326 may take improvement actions, such as, for example, pre-powering motors, user distraction, changes in the storyline with absence of actuation, and increased actuation consistent with the storyline to cover timing issues.

Timing prediction module 328 may be configured to predict timing issues based on the required synchronization metadata inserted in the content stream and the timestamp data received from various output devices by the real-time monitoring system.

Note that many of the elements described above in the local environment 302 could have been located in the cloud services 350. For example, timing prediction module 328 may be located in the cloud service 350 instead of in the local environment 302.

Haptic output device 330 includes devices configured to provide haptic or tactile output. In other words, haptic output devices provide a form of physical contact between the user and a computing device embedded within the haptic output device. The wrist-based device used in FIG. 1 is an example of a haptic output device 330. In FIG. 1, when the swords 108 and 110 clashed, the wrist-based device would provide a pulse/jolt to the user. Haptic output device 330 comprises haptic output 332, a clock 336, and a computing device 334. Haptic output 332, also referred to as actuators, may include haptic motors for wearables or game controllers, gas or chemical release (e.g., steam release to simulate smoke), bone-conducting speakers, projectile launchers, and the like. Actuators may be found in wearables, game controllers, and/or in the environment. They report their activation times to the real-time monitoring system 312.

Computing device 334 may be capable of delivering haptic output 332 to the haptic output device 330. Computing device 334 is described in more detail below with reference to FIGS. 8 and 9.

Clock 336 may be a shared real-time system clock, such as, for example, Network Time Protocol (NTP). Clock 336 may be used to report when actuator synchronization occurs for the haptic output device 330.

Projectile launcher 338 is a type of haptic output device 330 that projects objects outward based on a clock. Projectile launcher 338 comprises a motor 340, a clock 342, projectiles 344 and a computing device 346.

Motor 340 may be used to project the tactile outward. Clock 342 may be a shared real-time system clock, such as, for example, Network Time Protocol (NTP). Clock 342 may be used to report when actuator synchronization occurs for the projectile launcher 338.

Projectiles 344 may include a plurality of different tactiles that are propelled outward by the projectile launcher 338. Projectiles 344 are only influenced by the force of gravity thereby causing a vertical acceleration.

Computing device 346 may be capable of delivering projectiles 344 to the projectile launcher 338. Computing device 346 is described in more detail below with reference to FIGS. 8 and 9.

As indicated above, each clock 316, 336, 342, and 354, is a shared real-time clock, such as NTP. Each clock 316, 336, 342, and 354 comprises a subsystem that allows the comparison of timestamps from audio and video (reported from output devices 304) with timestamps from actuator outputs, such as, for example, haptic motors, reported from the output devices 330 and 338.

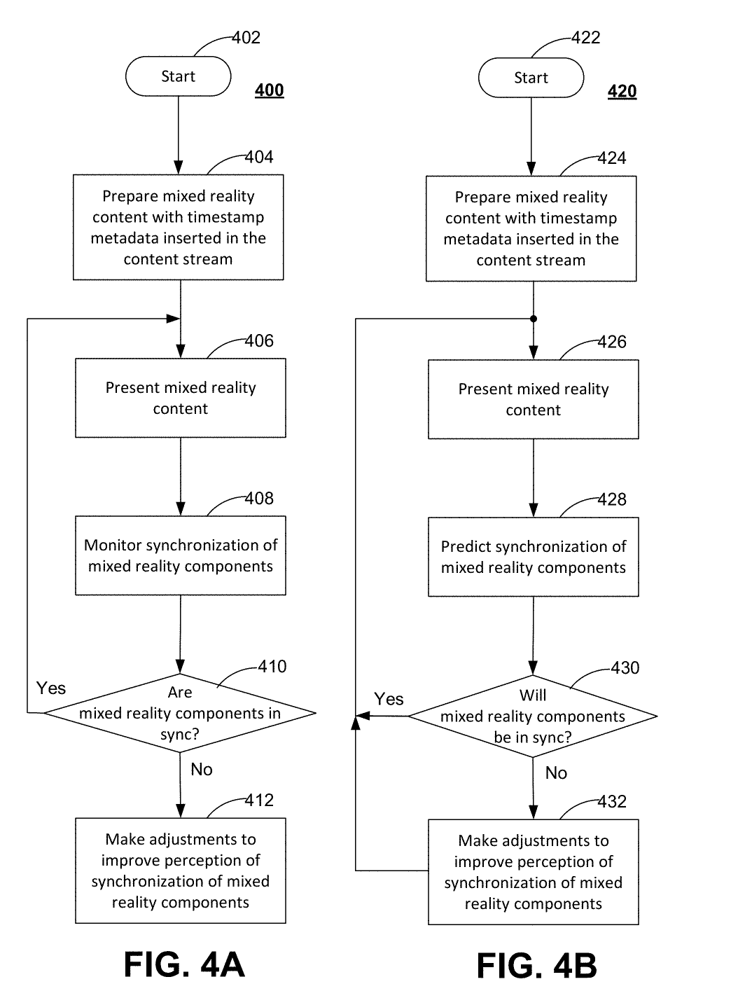

FIG. 4A is a flow diagram of an exemplary method 400 for monitoring and adjusting A/V/A synchronization in real-time according to an embodiment. The method 400 may generally be implemented in a computing system such as, for example, the computing system as shown in FIG. 9. More particularly, the method 400 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), and fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 400 may be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instruction, instruction set architecture (ISA) instructions, machine instruction, machine depended instruction, microcode, state setting data, configuration data for integrated circuitry, state information that personalizes electronic circuitry and/or other structural component that are native to hardware (e.g., host processor, central processing unit (CPU), microcontroller, etc.)

The process begins in block 402, where the process immediately proceeds to block 404.

In block 404, the system prepares the mixed reality content by inserting timestamp metadata into the content streams for audio, video, and actuation (if needed) to describe modality sync requirements. Mixed reality may include augmented reality, virtual reality, or a combination of both augmented and virtual reality. The content streams instruct the devices (i.e., output devices) on what to play and what to actuate. The timestamp metadata synchronizes these events by indicating when they should occur. In cases where certain components involved in actuation may need to happen faster in order to meet timestamp requirements, such as, for example, an actuator motor may need to begin spinning at a slower rate ahead of perceived actuation time to more quickly synchronize when instructed to do so. In such instances, the user may not feel the effects of the motor spin until the motor ramps up to full capacity. Full capacity will occur until the designated synchronization time for the actuator. The process then proceeds to block 406.

In block 406, the mixed reality content is presented to the output devices, such as, for example, output display devices 304, haptic output devices 330, and projectile launcher devices 338. The process then proceeds to block 408.

In block 408, the system monitors synchronization of the mixed reality components. For augmented reality, this may include A/V as well as A/V/A synchronization. For virtual reality, this may include A/V/A synchronization (sync). The process then proceeds to decision block 410.

In decision block 410, it is determined whether the mixed reality components are in sync. In one embodiment, the mixed reality components include audio and video (A/V) for augmented reality, and audio, video, and actuation (A/V/A) for augmented reality and virtual reality. If the mixed reality components are in sync, the process proceeds back to block 406, where mixed reality content is presented.

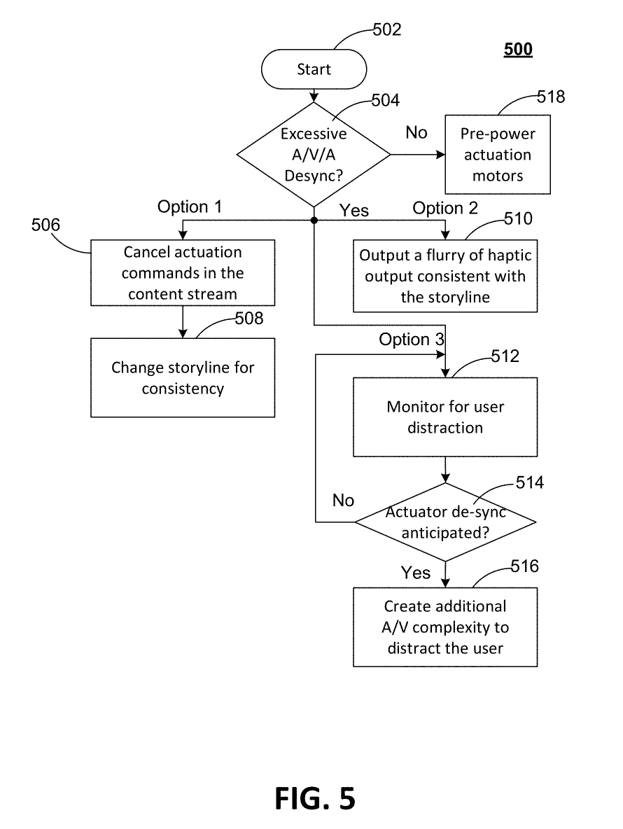

Returning to decision block 410, if it is determined that the mixed reality components are not in sync, the process then proceeds to block 412. In block 412, the system makes adjustments/compensates for not being in sync in order to improve the perception of synchronization of mixed reality components. Adjustments/compensation techniques are described below with reference to FIG. 5.

FIG. 4B is a flow diagram of an exemplary method 420 for predicting A/V/A synchronization according to an embodiment. The method 420 may generally be implemented in a computing system such as, for example, the computing system as shown in FIG. 9. More particularly, the method 420 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), and fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 420 may be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instruction, instruction set architecture (ISA) instructions, machine instruction, machine depended instruction, microcode, state setting data, configuration data for integrated circuitry, state information that personalizes electronic circuitry and/or other structural component that are native to hardware (e.g., host processor, central processing unit (CPU), microcontroller, etc.)

In systems with near real-time reaction to de-sync, the system may predict whether synchronization will be satisfactory. If the prediction indicates an unsatisfactory result, the system may make changes that alter the perception of A/V/A synchronization. The process begins in block 422, where the process immediately proceeds to block 424.

In block 424, the system prepares the mixed reality content by inserting timestamp metadata into the content streams for audio, video, and actuation (if needed) to describe modality sync requirements in a similar manner as described above with reference to block 404 in FIG. 4A. The process then proceeds to block 426.

In block 426, the system presents the mixed reality content. The process then proceeds to block 428.

In block 428, the system predicts A/V/A synchronization. Predictions may be made using the timing prediction module 328 shown in FIG. 3. The timing prediction module 328 predicts issues based on the synchronization metadata in the content streams and data received from the real-time monitoring system 312 (shown in FIG. 3). The process then proceeds to decision block 430.

In decision block 430, it is determined whether the mixed reality components meet expectations requirements (i.e., whether the mixed reality components are in sync). If the mixed reality components are in sync, the process proceeds back to block 426, where the system presents the mixed reality content.

Returning to decision block 430, if it is determined that the mixed reality components are not in sync, then the process proceeds to block 432.

In block 432, the system makes adjustments/compensates for not being in sync in order to improve the perception of synchronization of mixed reality components. Adjustments/compensation techniques are described below with reference to FIG. 5. The process then proceeds back to block 426, where the system presents the mixed reality content.

FIG. 5 is a flow diagram of an exemplary method for making adjustments to improve perception of A/V/A synchronization according to an embodiment. The method 500 may generally be implemented in a computing system such as, for example, the computing system as shown in FIG. 9. More particularly, the method 500 may be implemented in one or more module as a set of logic instructions stored in a machine- or computer-readable storage medium such as RAM, ROM, PROM, firmware, flash memory, etc., in configurable logic such as, for example, PLAs, FPGAs, CPLDs, and fixed-functionality logic hardware using circuit technology such as, for example, ASIC, CMOS or TTL technology, or any combination thereof.

To compensate for A/V/A de-sync, the mixed reality sync correction module 326 may take action to improve sync. The mixed reality sync correction module 326 utilized data from the real-time monitoring system 312, the timing prediction module 328, and the context engine 308.

The process begin in block 502 where the process immediately proceeds to decision block 504. In decision block 504, it is determined whether there is excessive A/V/A de-sync that cannot be avoided. If it is determined that there is excessive A/V/A de-sync that cannot be avoided, then the process may proceed to one of three alternative options found in blocks 506-508, 510, and 512-516.

In block 506 (option 1), action may be taken to cancel actuation commands in the content stream. If this option is taken, the process then proceeds to block 508, where the storyline is changed for consistency with the cancellation of the actuation commands.

In block 510 (option 2), the system increases actuation by outputting a flurry of haptic outputs that are consistent with the storyline.

In block 512 (option 3), with the help of the context engine 308, the system monitors for user distraction. The process then proceeds to decision block 514.

In decision block 514, it is determined whether actuator de-sync is anticipated. If actuator de-sync is anticipated, the process proceeds to block 516.

In block 516, additional A/V complexity is created to distract the user. Research has shown that user requirements for system latency may be less stringent under a high cognitive load (especially attention applied elsewhere) for the user.

Returning to decision block 504, if it is determined that the A/V/A de-sync problem is not excessive, then measures may be used to fix the synchronization issue. The process may proceed to block 518.

In block 518, actuator de-sync or predictions of actuator de-sync may be corrected by pre-powering actuation motors. In this instance, the system may respond to sync timestamps to power up actuation motors so that they can respond faster. For example, the system may initialize a haptic motor to spin slowly ahead of needed perceived actuation times so that it can more quickly sync.

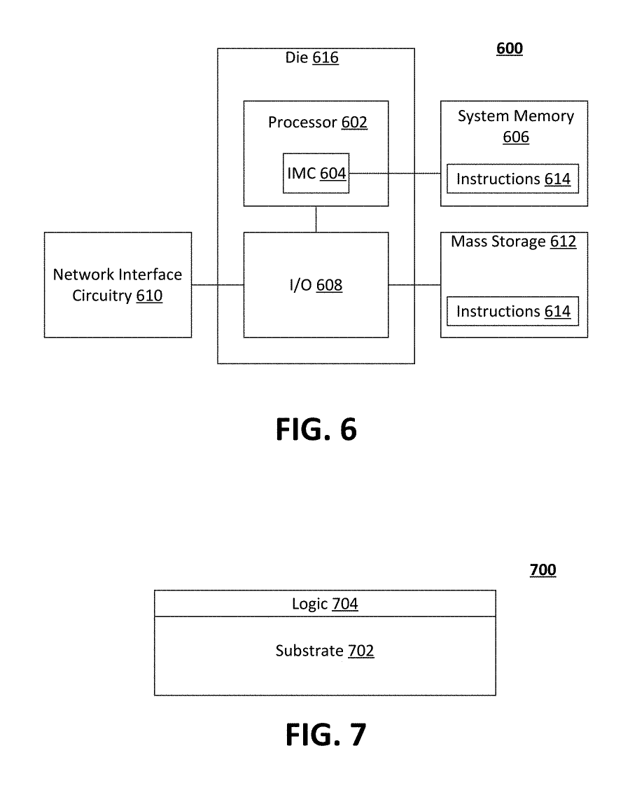

FIG. 6 shows a system 600 that may be readily substituted for the cloud service 350 or the local environment 302 (FIG. 3), already discussed. The illustrated system 600 includes a processor 602 (e.g., host processor, central processing unit/CPU) having an integrated memory controller (IMC) 604 coupled to a system memory 606 (e.g., volatile memory, dynamic random access memory/DRAM). The processor 602 may also be coupled to an input/output (I/O) module 608 that communicates with network interface circuitry 610 (e.g., network controller, network interface card/NIC) and mass storage 612 (non-volatile memory/NVM, hard disk drive/HDD, optical disk, solid state disk/SSD, flash memory).

The network interface circuitry 610 may receive sensor input data from a plurality of input/sensor devices 306 and synchronization timestamp data from the output devices to enable the real-time monitoring system 312 to monitor A/V/A synchronization, wherein the system memory 606 and/or the mass storage 612 may be memory devices that store instructions 614, which when executed by the processor 602, cause the system 600 to perform one or more aspects of the method 400 (FIG. 4A), the method 420 (FIG. 4B), and/or the method 500 (FIG. 5), already discussed. Thus, execution of the instructions 614 may cause the system 600 to prepare mixed reality content with metadata describing modality sync requirements and send the A/V/A content streams to the appropriate output devices, via the network interface circuitry 114, where the signals are monitored in real-time for meeting A/V/A synchronization requirements, wherein if A/V/A de-sync occurs, actions to improve the perception of A/V/A synchronization may be taken to ensure immersive mixed reality experiences for the user. The processor 602 and the 10 module 608 may be incorporated into a shared die 616 as a system on chip (SoC).

FIG. 7 shows a semiconductor package apparatus 700 (e.g., chip) that includes a substrate 702 (e.g., silicon, sapphire, gallium arsenide) and logic 704 (e.g., transistor array and other integrated circuit/IC components) coupled to the substrate 702. The logic 704, which may be implemented in configurable logic and/or fixed-functionality logic hardware, may generally implement one or more aspects of the method 400 (FIG. 4A), the method 420 (FIG. 4B), and/or the method 500 (FIG. 5), already discussed.

FIG. 8 illustrates a processor core 800 according to one embodiment. The processor core 800 may be the core for any type of processor, such as a micro-processor, an embedded processor, a digital signal processor (DSP), a network processor, or other device to execute code. Although only one processor core 800 is illustrated in FIG. 8, a processing element may alternatively include more than one of the processor core 800 illustrated in FIG. 8. The processor core 800 may be a single-threaded core or, for at least one embodiment, the processor core 800 may be multithreaded in that it may include more than one hardware thread context (or “logical processor”) per core.

FIG. 8 also illustrates a memory 870 coupled to the processor core 800. The memory 870 may be any of a wide variety of memories (including various layers of memory hierarchy) as are known or otherwise available to those of skill in the art. The memory 870 may include one or more code 805 instruction(s) to be executed by the processor core 800, wherein the code 805 may implement the method 400 (FIG. 4A), the method 420 (FIG. 4B), and the method 500 (FIG. 5), already discussed. The processor core 800 follows a program sequence of instructions indicated by the code 805. Each instruction may enter a front end portion 810 and be processed by one or more decoders 820. The decoder 820 may generate as its output a micro operation such as a fixed width micro operation in a predefined format, or may generate other instructions, microinstructions, or control signals which reflect the original code instruction. The illustrated front end portion 810 also includes register renaming logic 825 and scheduling logic 830, which generally allocate resources and queue the operation corresponding to the convert instruction for execution.

The processor core 800 is shown including execution logic 850 having a set of execution units 855-1 through 855-N. Some embodiments may include a number of execution units dedicated to specific functions or sets of functions. Other embodiments may include only one execution unit or one execution unit that can perform a particular function. The illustrated execution logic 850 performs the operations specified by code instructions.

After completion of execution of the operations specified by the code instructions, back end logic 860 retires the instructions of the code 805. In one embodiment, the processor core 800 allows out of order execution but requires in order retirement of instructions. Retirement logic 865 may take a variety of forms as known to those of skill in the art (e.g., re-order buffers or the like). In this manner, the processor core 800 is transformed during execution of the code 805, at least in terms of the output generated by the decoder, the hardware registers and tables utilized by the register renaming logic 825, and any registers (not shown) modified by the execution logic 850.

Although not illustrated in FIG. 8, a processing element may include other elements on chip with the processor core 800. For example, a processing element may include memory control logic along with the processor core 800. The processing element may include I/O control logic and/or may include I/O control logic integrated with memory control logic. The processing element may also include one or more caches.

Referring now to FIG. 9, shown is a block diagram of a computing system 1000 embodiment in accordance with an embodiment. Shown in FIG. 9 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 9 may be implemented as a multi-drop bus rather than point-to-point interconnect.

As shown in FIG. 9, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 8.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 9, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 9, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 9, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 500 (FIG. 5A), the method 520 (FIG. 5B), the method 540 (FIG. 5C), and/or the method 560 (FIG. 5D), already discussed, and may be similar to the code 805 (FIG. 8), already discussed. Further, an audio I/O 1024 may be coupled to second bus 1020 and a battery 1010 may supply power to the computing system 1000.

Note that other embodiments are contemplated. For example, instead of the point-to-point architecture of FIG. 9, a system may implement a multi-drop bus or another such communication topology. Also, the elements of FIG. 9 may alternatively be partitioned using more or fewer integrated chips than shown in FIG. 9.

### ADDITIONAL NOTES AND EXAMPLES

Example 1 may include a semiconductor package apparatus comprising a substrate, and logic coupled to the substrate, wherein the logic includes one or more of configurable logic or fixed-functionality hardware logic, the logic coupled to the substrate to prepare the mixed reality content with timestamp metadata in the content stream to describe modality synchronization requirements, present the mixed reality content, determine whether the components of the mixed reality content are in synchronization, and improve perception of the mixed reality content if the components of the mixed reality content are not in synchronization.

Example 2 may include the apparatus of Example 1, further comprising logic coupled to the substrate to monitor synchronization between components of the mixed reality content.

Example 3 may include the apparatus of Example 2, wherein if the components of the mixed reality content are in synchronization, the logic coupled to the substrate to track successful haptic output sync for specific users, across users, and specific devices, and continue to present the mixed reality content.

Example 4 may include the apparatus of Example 1, further comprising logic coupled to the substrate to predict synchronization between components of the mixed reality content.

Example 5 may include the apparatus of Example 1, wherein to improve perception of the mixed reality content comprises logic coupled to the substrate to perform at least one of pre-powering motors to enable fast response times for actuations, sending a flurry of haptic responses consistent with a storyline to cover excessive de-sync, removing actuation commands in the content stream and, if necessary, changing the storyline to cover the removal of the actuation commands, and monitoring for user distraction and creating additional audio/video complexity to distract the user.

Example 6 may include the apparatus of Example 1, wherein mixed reality components include at least two of audio, video, and actuation.

Example 7 may include the apparatus of Example 6, wherein if the actuation needs to sync quickly, the logic coupled to the substrate to respond to sync timestamps by pre-powering actuation motors for fast response times.

Example 8 may include the apparatus of any one of Examples 1 to 7, wherein mixed reality comprises augmented reality.

Example 9 may include the apparatus of any one of Examples 1 to 7, wherein mixed reality includes virtual reality.

Example 10 may include the apparatus of any one of Examples 1 to 7, wherein mixed reality includes augmented reality and virtual reality.

Example 11 may include a computing system to synchronize mixed reality content comprising network interface circuitry, a processor coupled to the network interface circuitry, and one or more memory devices coupled to the processor, the one or more memory devices including instructions, which when executed by the processor, cause the system to prepare the mixed reality content with timestamp metadata in the content stream to describe modality synchronization requirements, present the mixed reality content, determine whether the components of the mixed reality content are in synchronization, and improve perception of the mixed reality content if the components of the mixed reality content are not in synchronization.

Example 12 may include the computing system of Example 11, wherein the instructions, which when executed by the processor, cause the system to monitor synchronization between components of the mixed reality content.

Example 13 may include the computing system of Example 11 wherein the instructions, which when executed by the processor, cause the system to predict synchronization between components of the mixed reality content.

Example 14 may include the computing system of Example 11, wherein if the components of the mixed reality content are in synchronization, the instructions, which when executed by the processor, cause the system to track successful haptic output sync for specific users, across users, and specific devices, and continue to present the mixed reality content.

Example 15 may include the computing system of Example 11, wherein instructions to improve perception of the mixed reality content comprises instructions, which when executed by the processor, cause the system to perform at least one of to pre-power motors to enable fast response times for actuations, send a flurry of haptic responses consistent with a storyline to cover excessive de-sync, remove actuation commands in the content stream and, when necessary, change the storyline to cover the removal of the actuation commands, and monitor for user distraction and create additional audio/video complexity to distract the user.

Example 16 may include the computing system of Example 11, wherein mixed reality components include at least two of audio, video, and actuation.

Example 17 may include the computing system of Example 16, wherein if the actuation needs to sync quickly, further instructions, which when executed by the processor, cause the system to respond to sync timestamps by pre-powering actuation motors to enable fast response times.

Example 18 may include the computing system of any one of Examples 11 to 17, wherein mixed reality comprises augmented reality.

Example 19 may include the computing system of any one of Examples 11 to 17, wherein mixed reality includes virtual reality.

Example 20 may include the computing system of any one of Examples 11 to 17, wherein mixed reality includes augmented reality and virtual reality.

Example 21 may include a method for synchronizing mixed reality content, comprising preparing the mixed reality content with timestamp metadata in the content stream to describe modality synchronization requirements, presenting the mixed reality content, monitoring synchronization between components of the mixed reality content, determining whether the components of the mixed reality content are in synchronization, and improving perception of the mixed reality content if the components of the mixed reality content are not in synchronization.

Example 22 may include the method of Example 21, wherein if the components of the mixed reality content are in synchronization, tracking successful haptic output sync for specific users, across users, and specific devices and continuing to present the mixed reality content.

Example 23 may include the method of Example 21, wherein improving perception of the mixed reality content comprises at least one of pre-powering motors to increase response to sending a flurry of haptic responses consistent with a storyline to cover excessive de-sync, removing actuation commands in the content stream and, if necessary, changing the storyline to cover the removal of the actuation commands, and monitoring for user distraction and creating additional audio/video complexity to distract the user.

Example 24 may include the method of Example 21, wherein mixed reality components include at least two of audio, video, and actuation.

Example 25 may include the method of Example 24, wherein if the actuation needs to sync quickly, responding to sync timestamps by pre-powering actuation motors for fast response times.

Example 26 may include the method of any one of Examples 21 to 25, wherein mixed reality comprises augmented reality.

Example 27 may include the method of any one of Examples 21 to 25, wherein mixed reality includes virtual reality.

Example 28 may include the method of any one of Examples 21 to 25, wherein mixed reality includes augmented reality and virtual reality.

Example 29 may include at least one computer readable storage medium comprising a set of instructions, which when executed by a computing system, cause the computing system to prepare the mixed reality content with timestamp metadata in the content stream to describe modality synchronization requirements, present the mixed reality content, monitor synchronization between components of the mixed reality content, determine whether the components of the mixed reality content are in synchronization, and improve perception of the mixed reality content if the components of the mixed reality content are not in synchronization.

Example 30 may include the at least one computer readable storage medium of Example 29, wherein if the components of the mixed reality content are in synchronization, the instructions, when executed, cause the computing system to track successful haptic output sync for specific users, across users, and specific devices and continue to present the mixed reality content.

Example 31 may include the at least one computer readable storage medium of Example 29, wherein instructions to improve perception of the mixed reality content further comprise instructions, which when executed by the computing system, cause the computing system to perform at least one of to pre-power motors to enable fast response times for actuations, send a flurry of haptic responses consistent with a storyline to cover excessive de-sync, remove actuation commands in the content stream and, when necessary, change the storyline to cover the removal of the actuation commands, and monitor for user distraction and create additional audio/video complexity to distract the user.

Example 32 may include the at least one computer readable storage medium of Example 29, wherein mixed reality components include audio and video.

Example 33 may include the at least one computer readable storage medium of Example 29, wherein mixed reality components include at least two of audio, video, and actuation.

Example 34 may include the at least one computer readable storage medium of Example 33, wherein if the actuation needs to sync quickly, the instructions, when executed by the computing system, cause the computing system to respond to sync timestamps by pre-powering actuation motors to enable fast response times.

Example 35 may include the at least one computer readable storage medium of any one of Examples 29 to 35, wherein mixed reality includes augmented reality.

Example 36 may include the at least one computer readable storage medium of any one of Examples 29 to 35, wherein mixed reality includes virtual reality.

Example 37 may include the at least one computer readable storage medium of any one of Examples 29 to 35, wherein mixed reality includes augmented reality and virtual reality.

Example 38 may include a computing system for synchronizing mixed reality content comprising network interface circuitry, a processor coupled to the network interface circuitry, and one or more memory devices coupled to the processor, the one or more memory devices including instructions, which when executed by the processor, cause the system to prepare the mixed reality content with timestamp metadata in the content stream to describe modality synchronization requirements, present the mixed reality content, monitor synchronization between components of the mixed reality content, determine whether the components of the mixed reality content are in synchronization, and improve perception of the mixed reality content if the components of the mixed reality content are not in synchronization.

Example 39 may include the computing system of Example 38, wherein if the components of the mixed reality content are in synchronization, the instructions, which when executed by the processor, cause the system to track successful haptic output sync for specific users, across users, and specific devices, and continue to present the mixed reality content.

Example 40 may include the computing system of Example 38, wherein instructions to improve perception of the mixed reality content comprises instructions, which when executed by the processor, cause the system to perform at least one of to pre-power motors to enable fast response times for actuations, send a flurry of haptic responses consistent with a storyline to cover excessive de-sync, remove actuation commands in the content stream and, when necessary, change the storyline to cover the removal of the actuation commands, and monitor for user distraction and create additional audio/video complexity to distract the user.

Example 41 may include the computing system of Example 38 wherein mixed reality components include audio and video.

Example 42 may include the computing system of Example 38, wherein mixed reality components include at least two of audio, video, and actuation.

Example 43 may include the computing system of Example 42, wherein if the actuation needs to sync quickly, further instructions, which when executed by the processor, cause the system to respond to sync timestamps by pre-powering actuation motors to enable fast response times.

Example 44 may include the computing system of any one of Examples 38 to 43, wherein mixed reality comprises augmented reality.

Example 45 may include the computing system of any one of Examples 38 to 43, wherein mixed reality includes virtual reality.

Example 46 may include the computing system of any one of Examples 38 to 43, wherein mixed reality includes augmented reality and virtual reality.

Example 47 may include at least one computer readable medium comprising a set of instructions, which when executed by a computing system, cause the computing system to perform the method of any one of Examples 21 to 28.

Example 48 may include an apparatus comprising means for performing the method of any one of Examples 21 to 28.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1. A computing system comprising:
network interface circuitry;
a processor coupled to the network interface circuitry; and
one or more memory devices coupled to the processor, the one or more memory devices including instructions, which when executed by the processor, cause the system to:
prepare mixed reality content with timestamp audio, video, and actuation metadata in a content stream to describe modality synchronization requirements, wherein the actuation metadata describes haptic output, projectile launcher output, and other mechanical stimulation output to provide a user with a sense of physical contact;
present the mixed reality content;
determine whether audio, video, and actuation components of the mixed reality content are in synchronization; and
improve perception of the mixed reality content when the audio, video, and actuation components of the mixed reality content are not in synchronization.

2. The computing system of claim 1, wherein the instructions, which when executed by the processor, cause the system to monitor synchronization between the audio video, and actuation components of the mixed reality content.

3. The computing system of claim 1, wherein the instructions, which when executed by the processor, cause the system to predict synchronization between the audio, video, and actuation components of the mixed reality content.

4. The computing system of claim 1, wherein when the audio video, and actuation components of the mixed reality content are in synchronization, the instructions, which when executed by the processor, cause the system to:
track successful haptic output sync for specific users, across users, and specific devices; and
continue to present the mixed reality content.

5. The computing system of claim 1, wherein instructions to improve perception of the mixed reality content comprises instructions, which when executed by the processor, cause the system to perform one or more of to:
pre-power motors to enable fast response times for actuations; or
monitor for user distraction and create additional audio/video complexity to distract the user.

6. (canceled)

7. The computing system of claim 5, wherein if when the actuation needs to sync quickly, further instructions, which when executed by the processor, cause the system to respond to sync timestamps by pre-powering actuation motors to enable fast response times.

8. An apparatus comprising:
a substrate; and
logic coupled to the substrate, wherein the logic includes one or more of configurable logic or fixed-functionality hardware logic, the logic coupled to the substrate to:
prepare the mixed reality content with timestamp audio, video, and actuation metadata in a content stream to describe modality synchronization requirements, wherein the actuation metadata describes haptic output, projectile launcher output, and other mechanical stimulation output to provide a user with a sense of physical contact;
present the mixed reality content;
determine whether audio, video, and actuation components of the mixed reality content are in synchronization; and
improve perception of the mixed reality content when the audio, video, and actuation components of the mixed reality content are not in synchronization.

9. The apparatus of claim 8, further comprising logic coupled to the substrate to monitor synchronization between the audio, video, and actuation components of the mixed reality content.

10. The apparatus of claim 8, wherein when the audio, video, and actuation components of the mixed reality content are in synchronization, the logic coupled to the substrate to:
track successful haptic output sync for specific users, across users, and specific devices; and
continue to present the mixed reality content.

11. The apparatus of claim 8, further comprising logic coupled to the substrate to predict synchronization between the audio, video, and actuation components of the mixed reality content.

12. The apparatus of claim 8, wherein to improve perception of the mixed reality content comprises logic coupled to the substrate to perform one or more of:
pre-powering motors to enable fast response times for actuations;
sending a flurry of haptic responses consistent with a storyline to cover excessive de-sync;
removing actuation commands in the content stream and, when necessary, changing the storyline to cover the removal of the actuation commands; or
monitoring for user distraction and creating additional audio/video complexity to distract the user.

13. (canceled)

14. The apparatus of claim 12, wherein when the actuation needs to sync quickly, the logic coupled to the substrate to respond to sync timestamps by pre-powering actuation motors for fast response times.

15. A method of synchronizing mixed reality content, comprising:
preparing the mixed reality content with timestamp audio, video, and actuation metadata in a content stream to describe modality synchronization requirements;
presenting the mixed reality content;
monitoring synchronization between audio, video, and actuation components of the mixed reality content;
determining whether the audio, video, and actuation components of the mixed reality content are in synchronization, wherein the actuation metadata describes haptic output, projectile launcher output, and other mechanical stimulation output to provide a user with a sense of physical contact; and
improving perception of the mixed reality content when the audio, video, and actuation components of the mixed reality content are not in synchronization.

16. The method of claim 15, wherein when the audio, video, and actuation components of the mixed reality content are in synchronization, tracking successful haptic output sync for specific users, across users, and specific devices and continuing to present the mixed reality content.

17. The method of claim 15, wherein improving perception of the mixed reality content comprises one or more of:
pre-powering motors to increase response for actuations;
sending a flurry of haptic responses consistent with a storyline to cover excessive de-sync;
removing actuation commands in the content stream and, when necessary, changing the storyline to cover the removal of the actuation commands; or
monitoring for user distraction and creating additional audio/video complexity to distract the user.

18. (canceled)

19. The method of claim 17, wherein when the actuation needs to sync quickly, responding to sync timestamps by pre-powering actuation motors for fast response times.

20. At least one non-transitory computer readable storage medium comprising a set of instructions, which when executed by a computing system, cause the computing system to:
prepare the mixed reality content with timestamp audio, video, and actuation metadata in a content stream to describe modality synchronization requirements, wherein the actuation metadata describes haptic output, projectile launcher output, and other mechanical stimulation output to provide a user with a sense of physical contact;
present the mixed reality content;
monitor synchronization between audio, video, and actuation components of the mixed reality content;
determine whether the audio, video, and actuation components of the mixed reality content are in synchronization; and
improve perception of the mixed reality content when the audio, video, and actuation components of the mixed reality content are not in synchronization.

21. The at least one non-transitory computer readable storage medium of claim 20, wherein when the audio, video, and actuation components of the mixed reality content are in synchronization, the instructions, when executed, cause the computing system to track successful haptic output sync for specific users, across users, and specific devices and continue to present the mixed reality content.

22. The at least one non-transitory computer readable storage medium of claim 20, wherein instructions to improve perception of the mixed reality content further comprise instructions, which when executed by the computing system, cause the computing system to perform one or more of to:
pre-power motors to enable fast response times for actuations;
send a flurry of haptic responses consistent with a storyline to cover excessive de-sync;
remove actuation commands in the content stream and, when necessary, change the storyline to cover the removal of the actuation commands; or
monitor for user distraction and create additional audio/video complexity to distract the user.

23. (canceled)

24. (canceled)

25. The at least one non-transitory computer readable storage medium of claim 22, wherein when the actuation needs to sync quickly, the instructions, when executed by the computing system, cause the computing system to respond to sync timestamps by pre-powering actuation motors to enable fast response times.

26. The computing system of claim 1, wherein mixed reality content includes augmented reality and virtual reality.

27. The apparatus of claim 8, wherein mixed reality content includes augmented reality and virtual reality.

28. The method of claim 15, wherein mixed reality content includes augmented reality and virtual reality.

29. The at least one non-transitory computer readable storage medium of claim 20, wherein mixed reality content includes augmented reality and virtual reality.

30. The computing system of claim 1, wherein instructions to improve perception of the mixed reality content comprises instructions, which when executed by the processor, cause the system to send a flurry of haptic responses consistent with a storyline to cover excessive de-sync.

31. The computing system of claim 1, wherein instructions to improve perception of the mixed reality content comprises instructions, which when executed by the processor, cause the system to remove actuation commands in the content stream and, when necessary, change the storyline to cover the removal of the actuation commands.
